(19) United States
(12) Patent Application Publication
(10) Pub. No.: US 2017/0277795 A1
(43) Pub. Date: Sep. 28, 2017

(54) WEB PAGE SEARCH BAR

(71) Applicant: Taylor Christensen, Richmond, UT (US)

(72) Inventor: Taylor Christensen, Richmond, UT (US)

(21) Appl. No.: 15/080,738

(22) Filed: Mar. 25, 2016

(51) Int. Cl. G06F 17/30; G06Q 30/02; G06F 3/0481

(52) U.S. Cl. CPC G06F 17/30867; G06F 3/0481; G06Q 30/0282

(57) ABSTRACT

A method for consumer review retrieval over the internet including the steps of: creating a search engine protocol; implementing the search protocol into a web browser; posting a text entry box within the web browser; and initiating a retrieval of consumer reviews based upon data placed in the text entry box. The step of initiating preferably includes crawling through a plurality of web sites searching for consumer reviews related to the data, where the data includes either consumer products or services. The present invention further includes a system for consumer review retrieval over the internet that includes: web browser; a search engine protocol integrated into the web browser, where the search engine protocol relates to consumer review retrieval; and a text entry box available on the web browser, where the text entry box is available for data entry.

### BACKGROUND OF THE INVENTION

Field of Invention

The present invention relates to a search bar that is implemented onto a conventional web browser.

Description of Related Art

The Internet is used for various types of information and communications. News, politics, sports, self-help and other types of web pages are abundantly available for users. Many users use the Internet for shopping purposes. One typical aspect of Internet shopping involves consumer reviews that are posted by other consumers. Many products have reviews available on the Internet in various locations. Many times these reviews can be helpful in deciding whether to purchase a particular product or service. As a result, it would be advantageous to have a particular or a specialized search bar implemented into a typical search browser to assist in searching and retrieving product and service reviews.

### SUMMARY OF THE INVENTION

The present invention relates to a method for consumer review retrieval over the internet including the steps of: creating a search engine protocol; implementing the search protocol into a web browser; posting a text entry box within the web browser; and initiating a retrieval of consumer reviews based upon data placed in the text entry box. The step of initiating preferably includes crawling through a plurality of web sites searching for consumer reviews related to the data, where the data includes either consumer products or services. The present invention further includes a system for consumer review retrieval over the internet that includes: web browser; a search engine protocol integrated into the web browser, where the search engine protocol relates to consumer review retrieval; and a text entry box available on the web browser, where the text entry box is available for data entry. The search engine protocol includes web crawling protocols for crawling through a plurality of web sites searching for consumer reviews.

### BRIEF DESCRIPTION OF DRAWINGS

FIG. 1 depicts the implementation of a search bar in accordance with the present invention.

### DETAILED DESCRIPTION

The present invention relates to a search bar that is implemented onto a web page preferably integrated with an Internet browser to engage in searches for product reviews. The search bar according to present invention enables a user to have a dedicated search engine for retrieving various product and service reviews that are available across the Internet. As stated, many times consumers are faced with purchase decisions and wish to review product reviews that have been posted by various consumers. It can be sometimes tedious to retrieve these product reviews from the various web sites where these reviews may be posted. Further some reviews may be more helpful than others. The present invention provides a search bar dedicated for product service reviews that's integrated into the existing web browser of a user. The present invention includes instructions and protocol to achieve product review retrieval through the use of a single search. A text entry box is provided along at the center of a browser page that allows the user to type in a particular product or service in order to gain access to a particular review related thereto. The search engine easily retrieves a complete list of reviews available for the searcher. Through the use of this keyword and product entry, the search engine protocol retrieves product reviews related to a particular product. These products can relate to various types of products such as automotive products, electronics, beauty aids, weight loss systems and a multitude of other types of products and services.

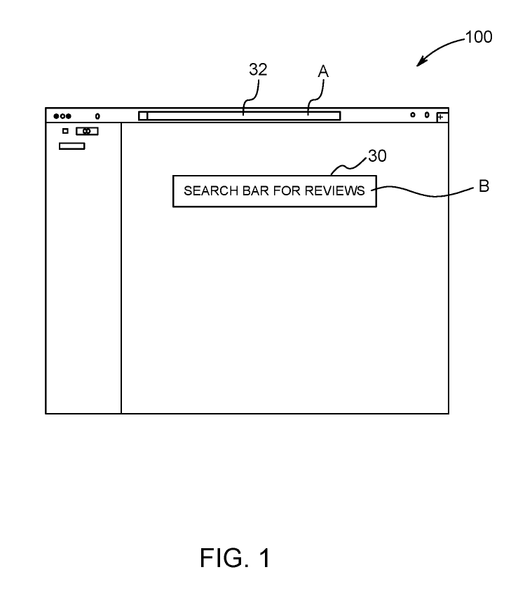

FIG. 1 depicts a Browser 100 that implements a Search Bar 30 for use by a user. A user may utilize the Search Bar 30 that is integrated into a Web Page 32. This Web Page 32 may be the home page for a particular Internet browser such as Firefox, Safari, Chrome or otherwise. Further the Search Bar 30 may retrieve various consumer reviews posted on web sites related to various department stores, general product stores and general merchandise Internet stores. Once implemented this Search Bar 30 provides an effective and easy means for the retrieval of product reviews related to a particular product. The instant invention has been shown and described in what it considers to be the most practical and preferred embodiments. It is recognized, however, that departures may be made there from within the scope of the invention and that obvious modifications will occur to a person skilled in the art.

What is claimed is:

1. A method for consumer review retrieval over the internet comprising the steps of:
a. creating a search engine protocol;
b. implementing the search protocol into a web browser;
c. posting a text entry box within the web browser; and
d. initiating a retrieval of consumer reviews based upon data placed in the text entry box.

2. The method according to claim 1, where the step of initiating includes crawling through a plurality of web sites searching for consumer reviews related to the data.

3. The method according to claim 1, where the data includes one of consumer products and consumer services.

4. A system for consumer review retrieval over the internet comprising:
a. web browser;
b. a search engine protocol integrated into the web browser, where the search engine protocol relates to consumer review retrieval; and
c. a text entry box available on the web browser, where the text entry box is available for data entry.

5. The system for consumer review retrieval according to claim 4, where the search engine protocol includes web crawling protocols for crawling through a plurality of web sites searching for consumer reviews.
